(19) United States
(12) Patent Application Publication
(10) Pub. No.: US 2011/0135230 A1
(43) Pub. Date: Jun. 9, 2011

(54) RADIAL ROLLER BEARING, IN PARTICULAR FOR THE ROLLER BEARING MOUNTING OF SHAFTS IN INTERNAL COMBUSTION ENGINES

(75) Inventors: Peter SOLFRANK, FRENSDORF (DE); Joachim SEITZ, SCHLUESSELFELD (DE); Patrick ULLMANN, HERZOGENAURACH (DE)

(73) Assignee: SCHAEFFLER TECHNOLOGIES GMBH & CO. KG, Herzogenaurach (DE)

(21) Appl. No.: 12/963,271

(22) Filed: Dec. 8, 2010

(30) Foreign Application Priority Data
Dec. 9, 2009 (DE) 10 2009 057 634.7

(51) Int. Cl. F16C 33/66; F16C 19/46; F16C 19/26

(52) U.S. Cl. 384/470

(57) ABSTRACT

A radial roller bearing, which has an outer bearing ring and a multiplicity of cylindrical roller bodies which roll on the inner lateral surface of the outer bearing ring and the outer lateral surface of an inner bearing ring or a shaft. The roller bodies are held at uniform intervals by a bearing cage with inwardly directed radial rims for axial guidance. Lubricating openings, which lead from the outside into the bearing interior, supply lubricant, and are arranged on the outer or inner bearing ring axially at both sides. The lubricating openings are cutouts which are formed into one or both axial sides of the bearing rings, outside a load zone of the bearing rings, which extend into the outer or inner raceway of the roller bodies and in which the roller bodies are arranged so as to be partially freely accessible for receiving oil form the bearing surroundings.

This application claims the priority of DE 10 2009 057 634.7 filed Dec. 9, 2009, which is incorporated by reference herein.

### DESCRIPTION

1. Field of the Invention

The invention relates to a radial roller bearing according to the precharacterizing features of Patent Claim 1, and can be applied particularly advantageously to needle-roller or cylindrical-roller bearings for the roller bearing mounting of shafts in internal combustion engines in an oil-mist-laden or spray-oil-laden environment.

2. Background of the Invention

To mount various shafts in internal combustion engines, such as crankshafts, camshafts and balancing shafts, use has increasingly been made recently of roller bearings instead of plain bearings in order to reduce friction, said roller bearings usually being formed by radial roller bearings. Aside from cylindrical-roller bearings and needle sleeves and needle bushes, solid needle-roller bearings have proven to be most suitable here, because they have a high load-bearing capacity and have a very low structural height in the radial direction and are therefore particularly suitable for structures with limited radial installation space. Such needle-roller bearings are known inter alia from the applicant's catalog “Wälzlager” [“Roller bearings”] dated January 2006, and are described for example on pages 620 to 655 in various embodiments with and without inner bearing rings. The most frequently used embodiment of such needle-roller bearings 1, which is shown in FIG. 1, is composed substantially of an outer bearing ring 2 and a multiplicity of cylindrical roller bodies 3 which roll on the inner lateral surface 5, which is formed as an outer raceway 4, of the outer bearing ring 2 and on the outer lateral surface 7, which is formed as an inner raceway 6, of an inner bearing ring 8, said cylindrical roller bodies 3 being held at uniform intervals with respect to one another in the circumferential direction by a bearing cage 9. Here, for the axial guidance of the roller bodies 3, inwardly directed radial rims 10, 11 are integrally formed on the outer bearing ring 2 axially at both sides, against which radial rims 10, 11 the roller bodies 3 run with their end surfaces, wherein such radial rims may also be integrally formed on the inner bearing ring 8, as is the case in cylindrical-roller bearings. Since it is the case in particular in internal combustion engines that an adequate supply of lubricant to the needle-roller bearings significantly influences the service life thereof and is therefore imperatively necessary, lubricating openings 12 which are spaced apart uniformly in the circumferential direction and which are formed as through bores are arranged axially centrally on the outer bearing ring 2, which lubricating openings 12 are connected to a supply line, which is charged with pressurized oil, in the bearing housing and are provided for supplying lubricant into the bearing interior. From other bearing designs, it is also known for such lubricating openings to be provided on the inner bearing ring or else on both bearing rings.

It has however been found in practice that a pressurized oil supply to the bearing points in internal combustion engines using the existing engine oil via supply lines and ducts provided specially for the purpose is relatively complex and expensive and also necessitates a corresponding level of power of the existing oil pump, which must otherwise be exchanged for a more powerful version, and this involves further effort. In the case of such a pressurized oil supply to the bearing points, there is likewise the risk of flooding of the roller bearing with lubricating oil, resulting in the desired friction reduction effect being reversed and the bearing friction being increased considerably. As an alternative to this, the utilization of the spray oil from the bearing surroundings in the interior of the internal combustion engine would duly be expedient, but the known roller bearings do not offer the required accessibility for the spray oil into the bearing interior, because the gap between the bearing cage abutting against the radial rims on the outer bearing ring and the inner bearing ring is not large enough to allow a sufficient amount of spray oil to pass into the bearing interior.

### OBJECT OF THE INVENTION

Taking the discussed disadvantages of the known prior art as a starting point, the invention is therefore based on the object of designing a radial roller bearing, in particular for the roller bearing mounting of shafts in internal combustion engines, which is supplied with the required lubrication at all times in a simple and cost-effective manner.

### DESCRIPTION OF THE INVENTION

According to the invention, in a radial roller bearing according to the preamble of Claim 1, said object is achieved in that the lubricating openings in the outer or inner bearing ring are formed as cutouts which are formed into one or both axial sides of the bearing rings outside the load zone of the bearing rings and which extend into the outer or inner raceway of the roller bodies and in which the roller bodies are arranged so as to be partially freely accessible for receiving spray oil from the bearing surroundings.

The invention is therefore based on the realization that, by means of cutouts, which are simple and cost-effective to produce, on the outer or inner bearing ring, it is possible to partially expose the roller bodies of the roller bearing such that said roller bodies can be supplied with a sufficient amount of spray oil from the bearing surroundings at all times. Here, to prevent a situation in which the roller bodies roll over the cutouts in the load zone of the bearing rings, and therefore to prevent an impairment in bearing function, the position of said cutouts on the bearing rings in the circumferential direction is dependent on the respective load direction in the intended application. At the same time, the respective rotational conditions in the application determine whether the cutouts should be arranged on the outer bearing ring or on the inner bearing ring. Generally, in the case of a fixed outer bearing ring and rotating inner bearing ring and in the case of a point load acting on the inner bearing ring, only the outer bearing ring is formed with the cutouts, on the side opposite the point load. Likewise, in the case of a fixed inner bearing ring and rotating outer bearing ring and in the case of a point load acting on the outer bearing ring, only the inner bearing ring is formed with the cutouts, on the side opposite the point load. However, if a circumferential load generated by an imbalance acts on one of the two bearing rings, as is the case in the mounting of balancing shafts of internal combustion engines, it should be ensured that, in the event of the imbalance being connected to the rotating outer bearing ring, only the outer bearing ring can be formed with the cutouts on the side of the acting imbalance, while in the event of the imbalance being connected to the rotating inner bearing ring, only the inner bearing ring can be formed with the cutouts on the side opposite the acting imbalance. In this way, the full raceway width on both bearing rings is made available to the roller bodies in the respective load zone.

Preferred embodiments and advantageous refinements of the radial roller bearing designed according to the invention are described in the subclaims.

Accordingly, according to Claim 2, it is provided in the radial roller bearing designed according to the invention that the outer bearing ring or the inner bearing ring has, on both axial sides, in each case three lubricating openings formed as cutouts. In this way, the outer or the inner bearing ring has a total of six such cutouts, which have generally proven to be sufficient to enable the roller bodies to receive spray oil for bearing lubrication. Depending on the size of the bearing, the number of cutouts on one of the two bearing rings may however be either increased or decreased. It is likewise possible for the cutouts to be arranged only on one axial side of the outer bearing ring or inner bearing ring if the corresponding bearing point is accessible to spray oil at only one side anyway.

According to Claims 3 and 4, the rolling bearing designed according to the invention is also characterized in that in each case two of the three cutouts on each axial side of the bearing rings are arranged exactly oppositely on a bearing transverse axis, and in that in each case one of the three cutouts on each axial side of the bearing rings is arranged opposite the load zone thereof on a bearing vertical. The two cutouts on the bearing transverse axis therefore have a spacing of 90° from the cutout on the bearing vertical, while the load zone, which is formed without a cutout, of the bearing ring is arranged opposite the cutout arranged on the bearing vertical. Such an arrangement of the cutouts on the bearing rings is however merely one preferred design, and does not rule out the possibility of the cutouts also being arranged with other spacings to one another.

In one expedient refinement of the rolling bearing designed according to the invention according to Claim 5, it is also provided that the cutouts in the bearing rings have in each case a width corresponding approximately to the axis spacing of two adjacent roller bodies. In this way, it is sought to ensure that the spray oil passing into the cutouts can penetrate into the bearing center between two roller bodies, and therefore all the bearing regions are supplied uniformly with oil. It is however also possible here for the width of the cutouts to be varied so as to be made larger or smaller, wherein a variation for making said width smaller, or a narrower design of the cutouts, is limited in that, in the case of too narrow a design of the cutouts, the amount of infiltrating spray oil may be too low for adequate bearing lubrication.

Finally, as an advantageous embodiment of the rolling bearing designed according to the invention, it is also proposed by Claim 6 that the cutouts in the bearing rings are of rectangular shape and have in each case a depth corresponding to approximately one third of the width of the bearing rings. This design has also proven to be ideal for ensuring that the spray oil infiltrating into the cutouts can penetrate into the bearing center, and therefore all the bearing regions are supplied uniformly with oil. However, shapes of the cutouts which differ from this, for example a semi-circular or trapezoidal design, and/or different depths of the cutouts are also possible if this contributes to a further improvement in bearing lubrication.

### BRIEF DESCRIPTION OF THE DRAWINGS

The radial roller bearing designed according to the invention is explained in more detail below in terms of two preferred embodiments, with reference to the appended drawings in which:

FIG. 1 shows an enlarged cross section through a solid needle-roller bearing according to the prior art;

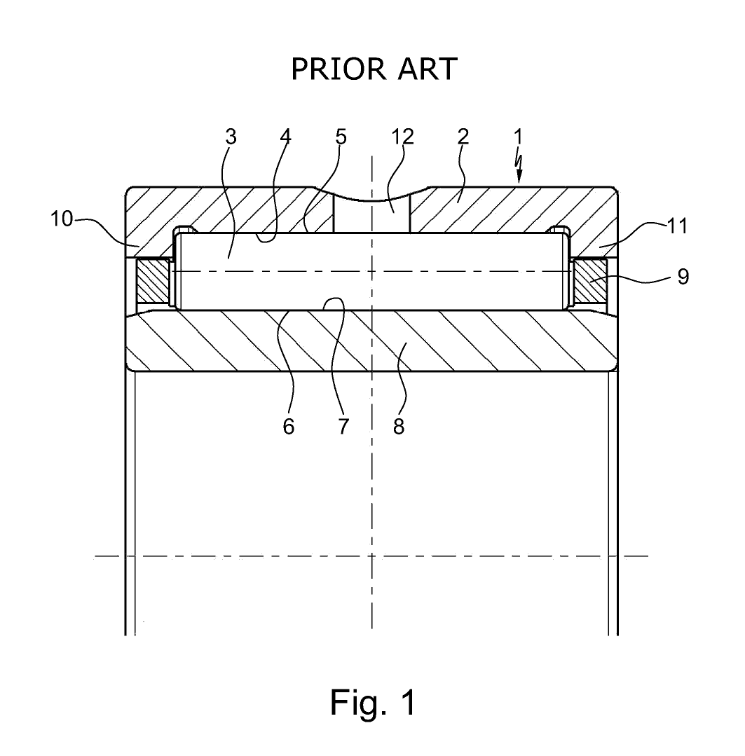

FIG. 2 shows an exploded illustration of a first embodiment of a solid needle-roller bearing designed according to the invention;

FIG. 3 shows an exploded illustration of a second embodiment of a solid needle-roller bearing designed according to the invention.

### DETAILED DESCRIPTION OF THE DRAWINGS

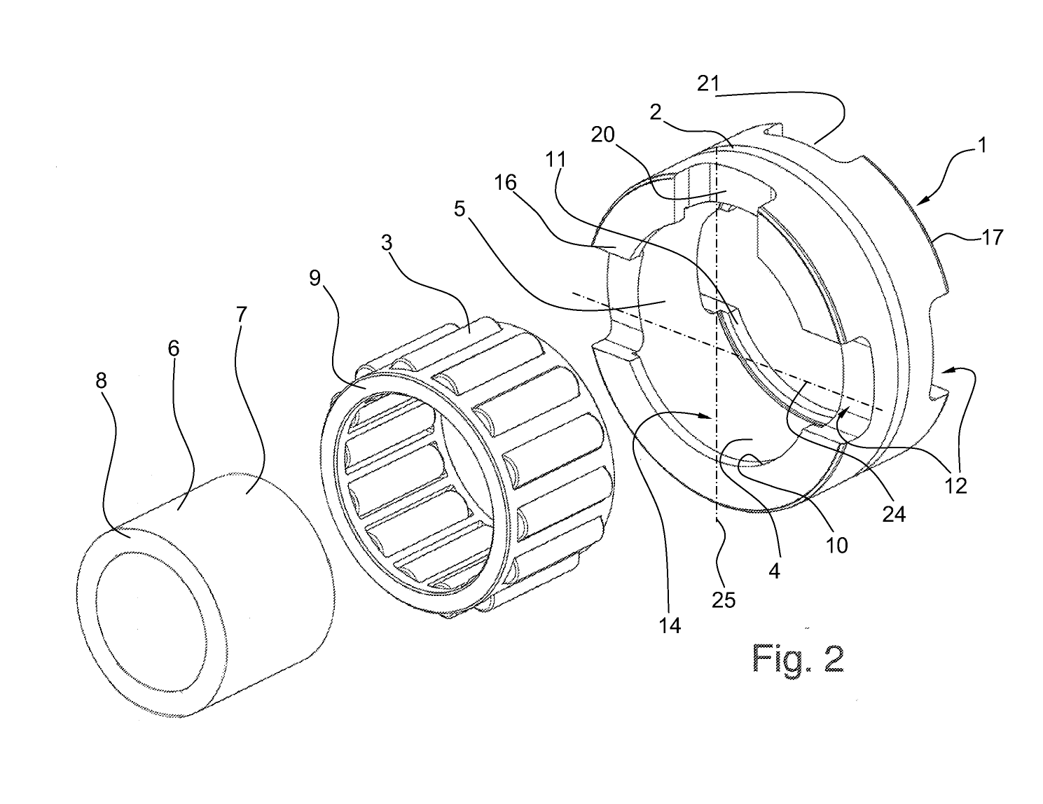

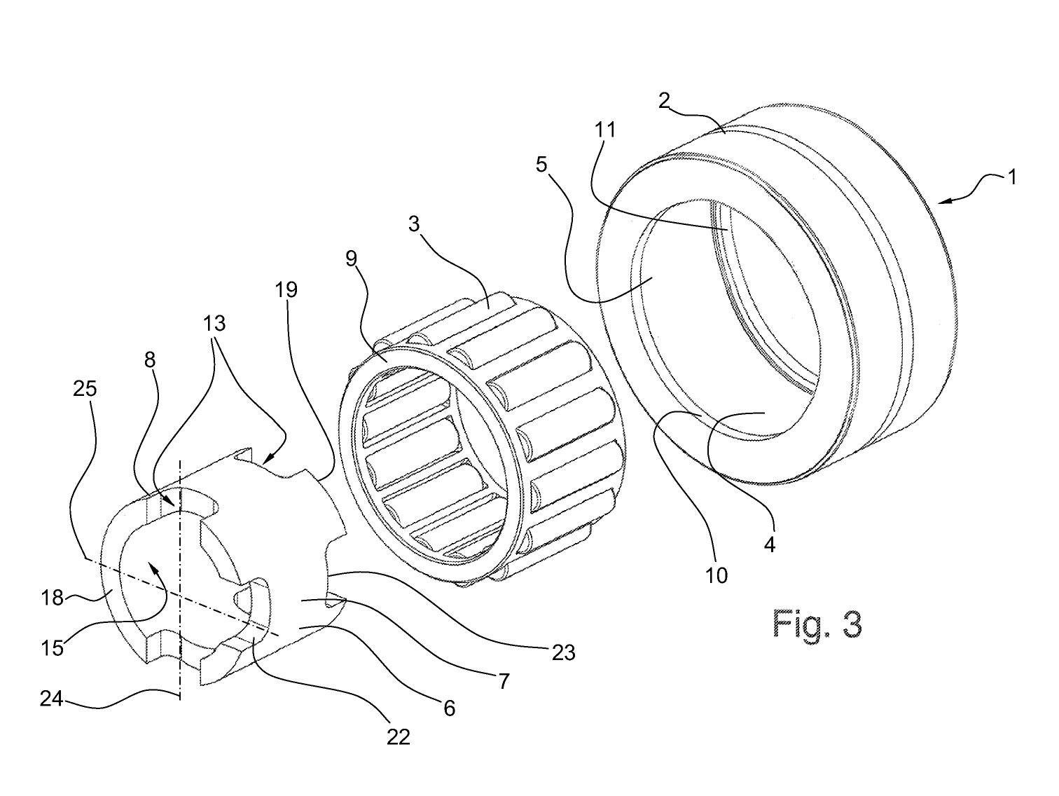

FIGS. 2 and 3 show in each case an exploded illustration of a radial roller bearing 1 which is designed as a solid needle-roller bearing and which is composed substantially of an outer bearing ring 2 and a multiplicity of cylindrical roller bodies 3 which roll on the inner lateral surface 5, which is formed as an outer raceway 4, of the outer bearing ring 2 and on the outer lateral surface 7, which is formed as an inner raceway 6, of an inner bearing ring 8, said cylindrical roller bodies 3 being held at uniform intervals with respect to one another in the circumferential direction by a bearing cage 9. Here, inwardly directed radial rims 10, 11 for the axial guidance of the roller bodies 3 are arranged on the outer bearing ring 2 axially at both sides, against which radial rims 10, 11 the roller bodies 3 run with their end surfaces.

It can also be clearly seen from FIGS. 2 and 3 that the radial roller bearing 1 shown in FIG. 2 has lubricating openings 12 leading from the outside into the bearing interior, and the radial roller bearing 1 shown in FIG. 3 has lubricating openings 13 leading from the outside into the bearing interior, for a supply of lubricant, said lubricating openings being formed according to the invention as cutouts 20, 21 and 22, 23 which are formed into both axial sides 16, 17 and 18, 19 of the bearing rings 2, 8 outside the load zone 14, 15 of the bearing rings 2, 8. Here, it is possible to clearly see in each case three lubricating openings 12, 13, formed as cutouts 20, 21 and 22, 23, in the outer bearing ring 2 or the inner bearing ring 8, which lubricating openings extend into the outer raceway 4 or inner raceway 6 of the roller bodies 3 on the bearing rings 2, 8 and therefore make the roller bodies 3 partially freely accessible for receiving spray oil from the bearing surroundings.

Finally, it can also be seen from FIGS. 2 and 3 that in each case two of the three cutouts 20, 21 on the axial sides 16, 17 of the outer bearing ring 2 and two of the three cutouts 22, 23 on the axial sides 18, 19 of the inner bearing ring 8 are arranged exactly oppositely on a bearing transverse axis 24 (illustrated by a dash-dotted line), while in each case one of the three cutouts 20, 21 on the axial sides 16, 17 of the outer bearing ring 2 and one of the three cutouts 22, 23 on the axial sides 18, 19 of the inner bearing ring 8 is arranged opposite the load zone 14, 15 thereof on a bearing vertical 25 (likewise illustrated by a dash-dotted line). Here, all the cutouts 20, 21, 22, 23 in the bearing rings 2, 8 are of rectangular design and have in each case a width corresponding approximately to the axis spacing of two adjacent roller bodies 3, and in each case a depth corresponding to approximately one third of the width of the bearing rings 2, 8.

### LIST OF REFERENCE NUMERALS

1 Radial roller bearing
2 Outer bearing ring
3 Roller body
4 Outer raceway of 3
5 Inner lateral surface of 2
6 Inner raceway of 3
7 Outer lateral surface of 8
8 Inner bearing ring
9 Bearing cage
10 Radial rim on 2
11 Radial rim on 2
12 Lubricating openings in 2
13 Lubricating openings in 8
14 Load zone on 2
15 Load zone on 8
16 Axial side of 2
17 Axial side of 2
18 Axial side of 8
19 Axial side of 8
20 Cutouts in 16
21 Cutouts in 17
22 Cutouts in 18
23 Cutouts in 19
24 Bearing transverse axis
25 Bearing vertical

1. A radial roller bearing for a roller bearing mounting of shafts in internal combustion engines, comprising:
an outer bearing ring and a multiplicity of cylindrical roller bodies which roll on an inner lateral surface, which is formed as an outer raceway, of the outer bearing ring and on an outer lateral surface, which is formed as an inner raceway, of an inner bearing ring or of a shaft to be mounted, the cylindrical roller bodies being held at uniform intervals with respect to one another in a circumferential direction by a bearing cage, with inwardly directed radial rims for axial guidance of the rolling bodies, and lubricating openings which lead from an outside into a bearing interior and serve for a supply of lubricant, being arranged on the outer bearing ring or on the inner bearing ring axially at both sides,
wherein the lubricating openings in the outer bearing ring or the inner bearing ring are formed as cutouts which are formed into one or both axial sides of the bearing rings outside a load zone of the bearing rings and which extend into the outer raceway or the inner raceway of the roller bodies and in which the roller bodies are arranged so as to be partially freely accessible for receiving spray oil from the bearing surroundings.

2. The radial roller bearing according to claim 1, wherein the outer bearing ring or the inner bearing ring has, on both axial sides, three lubricating openings formed as cutouts.

3. The radial roller bearing according to claim 2, wherein two of the three cutouts on the axial sides of the outer bearing ring or the inner bearing ring are arranged exactly oppositely on a bearing transverse axis.

4. The radial roller bearing according to claim 2, wherein in each case one of the three cutouts on each axial side of the outer bearing ring or the inner bearing ring is arranged opposite the load zone thereof on a bearing vertical.

5. The radial roller bearing according to claim 2, wherein the cutouts in the outer bearing ring or the inner bearing ring each have a width corresponding approximately to the axis spacing of two adjacent roller bodies.

6. The radial roller bearing according to claim 2, wherein the cutouts in the outer bearing ring or the inner hearing ring are of rectangular shape and have a depth corresponding to approximately one third of a width of the outer bearing ring or the inner hearing ring.
